(19) United States
(12) Patent Application Publication
(10) Pub. No.: US 2006/0033971 A1
(43) Pub. Date: Feb. 16, 2006

(54) AUTOMATED TRAPPING SYSTEM FOR DESKTOP PUBLISHING

(75) Inventor: David Allen, Denver, CO (US)

Correspondence Address: FAEGRE & BENSON LLP;PATENT DOCKETING, 2200 WELLS FARGO CENTER, MINNEAPOLIS, MN, 55402, US

(73) Assignee: Quark, Inc., Denver, CO (US)

(21) Appl. No.: 10/710,944

(22) Filed: Aug. 13, 2004

(51) Int. Cl. H04N 1/46

(52) U.S. Cl. 358/537

(57) ABSTRACT

A trapping process that evaluates values relating to the luminance of the colors as well as the ink components of each of the colors. The trapping process is then able to determine the direction of the trapping of each the objects on an ink by ink basis. The trapping process of a preferred embodiment evaluates not only the luminance of the color of each of the objects but also the luminance of each of the ink components of the colors of each of the objects. This allows the trapping process to determine the trapping direction of the objects on an ink by ink basis.

### BACKGROUND OF INVENTION

This application claims the benefit of U.S. Provisional Application 60/489,869, filed on Aug. 24, 2003.

Electronic printing of multi-color pages are typically printed on multiple separations to provide high quality publications. This printing process typically uses four process colors (Cyan, Magenta, Yellow, Black) plus additional spot colors as need (Red, Green, Blue or other color models). Each of the process colors require individual film separations or printing plates. Spot colors then require additional separations or printing plates for each spot color utilized.

A problem that often arises is when misregistration of these separations occur. Such misregistrations cause a slight shift in colors of foreground objects and background objects in the printed document. Since printing inks are not completely opaque, printing one ink over another (also known as overprinting) will create a third color. This is desirable when the color of the foreground object is black, or when you wish to mix two colors. However, if the color of the foreground object is to be printed without mixing with the background color(s), a knockout, or unprinted area, in the shape of the foreground object can be made in the color plates that compose the background. In a perfect world, all foreground objects would knock out on their background plates. However, printing inaccuracies caused by the shifting of paper on a press can cause gaps between colored items. To compensate for inevitable errors like these, a trap can be created to slightly overprint two colors along their borders. A typical trap can be created using one of two methods: 1. Spreading a foreground object so its edges overlap the edges of its knocked out shape on the background plates; or 2. Choking (reducing slightly) the knockout shape, so the edges of the knockout overlap the edges of the foreground object.

Other types of trapping use frames or defined border regions between color pairs. These frames are then filled with a composite color based on a series of complex rules.

The trapping process can be applied manually during the printing process, during the post-processing of the document (after the printer definition files have been created) or as is now becoming increasingly more prevalent, during the preparation of the document to be published, such as in graphic editing, drawing, layout or other desktop publishing programs. Most desktop publishing programs offer some form of automated trapping to correct such misregistrations.

These automated trapping processes typically apply rules to determine the region of a trap at the boundaries between foreground and background objects and the nature of the trap to be applied. These rules normally find the edges of an image, determine the color to be used for trapping, determine where that color should be placed and modify the image accordingly.

The rules typically determine the difference between the luminance or lightness values to determine the color to be applied and the direction that the trapping should be applied. Normally, the lighter color is spread into the darker color. Most typical trapping systems do this on an object base, as opposed to an ink by ink basis. In many instances however, this creates an inappropriate trapping in the printed object. This is particularly an issue where unique colors having gray values and rich black values appear in the objects being printed.

There is a need for a trapping system and method that will determine the appropriate trapping for different situations.

### SUMMARY OF INVENTION

The present invention, in a preferred embodiment, provides systems and processes for automatically trapping misregistrations of printing separations. It solves many of the problems with prior trapping systems that are commonly used in desktop publishing systems and other systems where such misregistrations occur.

In a preferred embodiment of the present invention, the trapping process allows automatic correction of defects involving colors that normal trapping processes fail to properly correct. For example, the present system evaluates the ink value components of each of the colors of the objects being printed to determine the direction of the trapping.

The trapping process of a preferred embodiment of the present invention is able to evaluate values relating to the luminance of the colors as well as the ink components of each of the colors. The trapping process is then able to determine the direction of the trapping of each the objects on an ink by ink basis.

The trapping process of a preferred embodiment evaluates not only the luminance of the color of each of the objects but also the luminance of each of the ink components of the colors of each of the objects. This allows the trapping process to determine the trapping direction of the objects on an ink by ink basis.

In a preferred embodiment of the present invention, the trapping process evaluates the gray values of each of the ink components of the colors of the objects. These gray values are applied to a threshold value for gray values set by the system or by the user to determine the direction of trapping, including knockouts or overprinting.

These gray values may also be applied against a threshold for rich black that is set by the system or by the user. The determination as to whether a rich black is occurring for the color of the object (even when there is no black component) is used to determine the direction of trapping.

The rich black and partial gray features may be selected by the user, or turned off in not desired. Other features which may be selected by the user includes the size of the trapping region, the ink offset (when the objects share a common ink), the density of the trap and whether to consider previous trapping by the background object.

The trapping process of a preferred embodiment of the present invention initially paints each object. Then a trap zone is created for each of the objects. This trap zone is then painted by either the foreground object or the background object on an ink by ink basis. The direction of the trapping, that is, spreading, choking, knockout or overprint is based upon evaluations of each color and ink component of each color for each object.

The process evaluates, in a preferred embodiment, the luminance of the colors, the luminance of each ink component of the colors, the total gray value for each color and the gray value for each ink component. The gray values are then applied against threshold values for rich black and for gray, if those features are selected by the user.

If any ink has a partial gray value that is greater than the gray threshold, than the object having that ink will knockout the other object. An offset value is provided in the event of a tie between inks. If any color has an ink with a partial gray value that is greater than the rich black threshold and an ink with a partial gray value that is less than the rich black threshold, then that object will overprint the other object. Otherwise, the object having a color with greater luminance than the other color of the other object will spread relative to the other object.

These and other features of the present invention will be evident from the ensuring detailed description of preferred embodiments and from the drawings.

### BRIEF DESCRIPTION OF DRAWINGS

FIG. 1 is an illustration of artwork printed with printing separations.

FIG. 2 is an illustration of a Cyan printing plate of the artwork of FIG. 1.

FIG. 3 is an illustration of a Magenta printing plate of the artwork of FIG. 1.

FIG. 4 is an illustration of a Yellow printing plate of the artwork of FIG. 1.

FIG. 5 is an illustration of a Black printing plate of the artwork of FIG. 1.

FIG. 6 is an illustration of the artwork with bleeding areas due to the misregistration of the printing plate.

FIG. 7 is a diagram of the overall trapping process of a preferred embodiment of the present invention.

FIG. 8 is an illustration of artwork that utilizes the trapping process of a preferred embodiment of the present invention.

FIG. 9 is an illustration of the Cyan printing plate of the artwork of FIG. 8.

FIG. 10 is an illustration of the Magenta printing plate of the artwork of FIG. 8.

FIG. 11 is an illustration of the Yellow printing plate of the artwork of FIG. 8.

FIG. 12 is an illustration of the Black printing plate of the artwork of FIG. 8.

FIG. 13 is an illustration of the spot color printing plate of the artwork of FIG. 8.

FIG. 14 is an illustration of artwork that utilizes the trapping process of a preferred embodiment of the present invention.

FIG. 15 is an illustration of the Cyan printing plate of the artwork of FIG. 14.

FIG. 16 is an illustration of the Magenta printing plate of the artwork of FIG. 14.

FIG. 17 is an illustration of the Yellow printing plate of the artwork of FIG. 14.

FIG. 18 is an illustration of the Black printing plate of the artwork of FIG. 14.

FIG. 19 is an illustration of the spot color printing plate of the artwork of FIG. 14.

FIG. 20 is an illustration of artwork that utilizes the trapping process of a preferred embodiment of the present invention.

FIG. 21 is an illustration of the Cyan printing plate of the artwork of FIG. 20.

FIG. 22 is an illustration of the Magenta printing plate of the artwork of FIG. 20.

FIG. 23 is an illustration of the Yellow printing plate of the artwork of FIG. 20.

FIG. 24 is an illustration of the Black printing plate of the artwork of FIG. 20.

FIG. 25 is an illustration of the spot color printing plate of the artwork of FIG. 20.

FIGS. 26-31 provide another illustration of trapping techniques of the preferred embodiment of the present invention.

### DETAILED DESCRIPTION

The present invention, in a preferred embodiment, provides systems and processes for automatically trapping misregistrations of printing separations. A preferred embodiment of the present invention is described below. It is to be expressly understood that this descriptive embodiment is provided for explanatory purposes only, and is not meant to unduly limit the scope of the present invention as set forth in the claims. Other embodiments of the present invention are considered to be within the scope of the claimed inventions, including not only those embodiments that would be within the scope of one skilled in the art, but also as encompassed in technology developed in the future.

Terminology Although some of the terms in this application may be common trapping terminology or principles, they may have a slightly different meaning in the context of the desktop publishing system functionality and in the context of this application. For purposes of this application, the following terms are defined as set forth: Trap Zone The area of potential trapping of intersecting objects.

Foreground object A text, line, frame or box object that overlaps another text, line, frame or box object.

Background object A text, line frame or box object that is overlapped by another text, line, frame or box object.

Text object A text character or series of text characters.

Box object Any object in that can contain either text or a picture.

Line object Any line drawn in the desktop publishing program.

Ink The printing plate under consideration.

Choke When the ink of the background object encroaches the intersection of the foreground object.

Spread When the ink of the foreground object encroaches the intersection of the background object.

Knockout When a background object forms an aperture that is void of ink precisely the same size as the foreground object.

Overprint When the background object prints in its entirety underneath the foreground object.

Auto Amount (+) When the Auto Amount in the trapping preferences is applied to a foreground object to product a choke relationship.

Auto Amount (−) When the Auto Amount in the trapping preferences is applied to a foreground object to product a choke relationship.

Indeterminate Amount The trapping value applied to objects when the background color cannot be evaluated or has conflicting relationships with the foreground object.

Partial luminance The independent lightness measurement of each process component. (C, M, Y and K.)Total luminance The sum of each process component's lightness.

Gray Value Any color value where all three color components are equal. This gray value is sometimes referred to as the intensity of a pixel.

Rich Black A composite black, that is a black formed from colors in addition to black to create a deeper black.

Win When either the foreground or the background object should perform the trap based on an evaluation of their color or gray value relationship.

Lose When either the foreground or the background object should not perform the trap based on an evaluation of their color or gray value relationship. Also: lost, losing and loser.

Vector An arbitrary description of painted objects in a mathematical system of coordinates.

Raster An array of solid colored tiles arranged in rows and columns that collectively produce an image.

Multi-Color Background 1) a blend that uses at least one color that is uncommon with the foreground object. 2) multiple objects that have fill colors uncommon with the foreground object. 3.) a line of text that partially overlapping a relatively dark background and a white background.

Indeterminate Background when the background is an imported image with color cannot be evaluated for trapping.

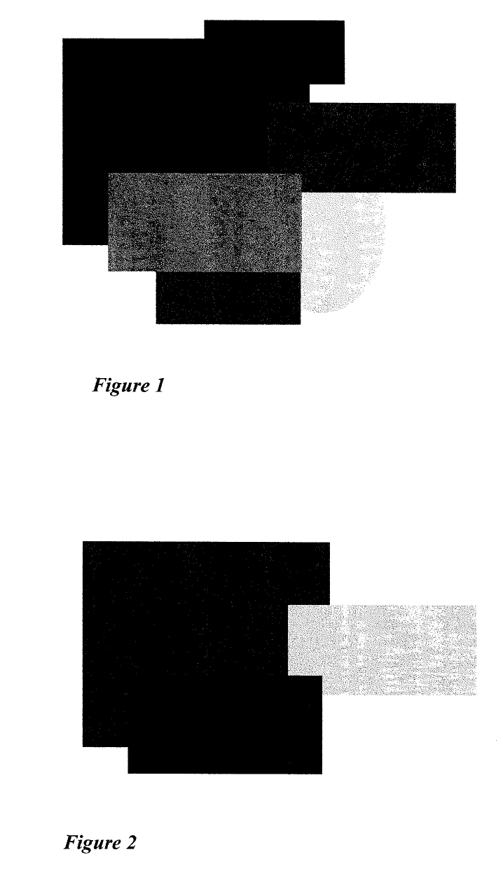

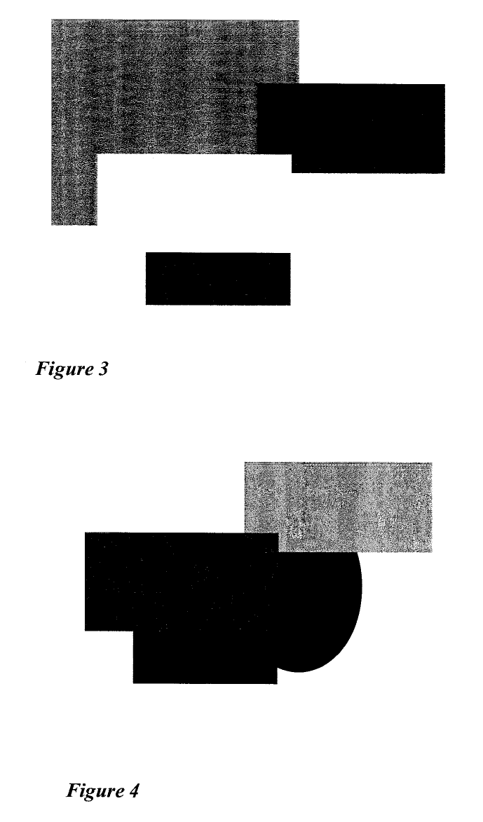

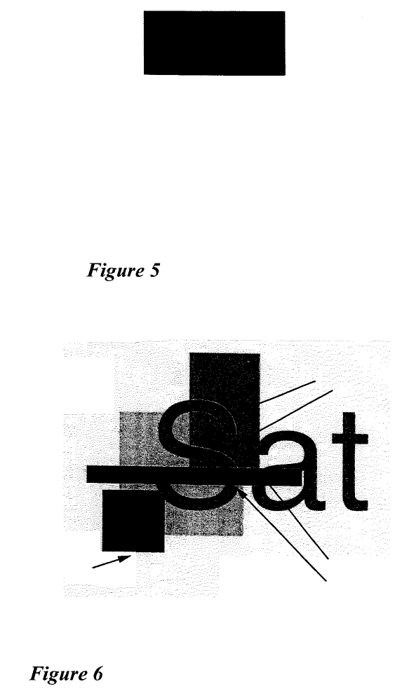

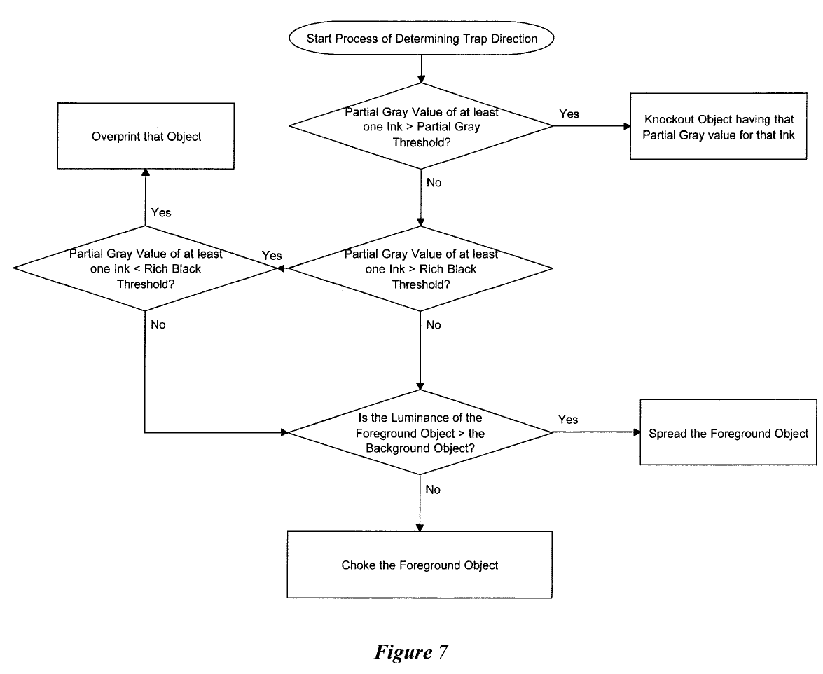

An example of artwork for an illustration is shown in FIGS. 1-5 using a four color separation process (Cyan, Magenta, Yellow and Black) along with a spot color. FIG. 1 illustrates a composite color figure. FIG. 2 illustrates the Cyan ink separation plate, FIG. 3 illustrates the Magenta separation plate, FIG. 4 illustrates the Yellow separation plate, and FIG. 5 illustrates the Black separation plate. These plates are combined to form the artwork as designed.

However, typically some misregistration between these plates occurs during the printing press. FIG. 6 illustrates a typical misregistered print having areas as indicated by the arrows allowing small areas of white to bleed through.

The present invention provides processes and systems for compensating for such misregistrations. The systems and processes in a preferred embodiment of the present invention for automated trapping stems from a very basic principle. That principle is to establish a trapping zone and to enlarge or reduce the current ink of the background object relative to the foreground object. The current ink is a term for the current printing plate being described, processed and/or printed. In order to do this, each object in a given page description may have to be described many times. This is accomplished by saving the essential object and the environmental components relating to this essential object at the time just before that object is first painted. Each object is then saved either in an array or to hard disk in the order in which they are described. This order will be the bottom most object to the top most object.

After each object is painted, a trap zone is created around the object and each of the previously described object(s), starting with the bottom most object, are painted in turn using either the ink value of the foreground object or the background ink value. The system of a preferred embodiment of the present invention evaluates the foreground object and the background object to determine the trapping behavior to be applied in that particular situation.

The system of a preferred embodiment of the present invention for automated trapping uses the following evaluations to perform the appropriate automated trapping behavior:

1. total luminance evaluation.

2. partial luminance evaluation.

3. total gray evaluation.

4. partial gray evaluation.

5. principle gray evaluation.

These evaluations are explained below.

1. Total Luminance Evaluation

The total luminance for each of the two colors involved in the trap relationship are evaluated. This is done by assessing the RGB value of each composite color applying this formula to both colors:(Red×0.3)+(Green×0.59)+(Blue×0.11)=Luminance.

The RGB value of a composite color is based on the RGB color model where all of the colors that make up an image are made up of a combination of red, green, and blue at varying levels of intensity, each ranging from 0-255. Each unique color has its own combination of red, green, and blue levels.

2. Partial Luminance Evaluation

The partial luminance for each of the composite colors involved in the trap relationship is evaluated. The partial luminance is the luminance of each ink comprising the composite color. This is determined by assessing the RGB value of a given ink and applying the formula:(Red×0.3)+(Green×0.59)+(Blue×0.11)=Luminance.

3. Total Gray Evaluation

The total gray is a hypothetical gray value comprising the sum of the ink gray values. This is a hypothetical value in that the total gray is often a value that exceeds that of a typical black. The total gray value has no practical purpose other than the use of it as a yard stick to determine the relative gray contribution of any one ink used in the composite color. The total gray is determined using this formula:(1 ink1 partial luminance)+(1−ink2 partial luminance)+(1 ink3 partial luminance)+(1−ink4 partial luminance)=total gray. In this example, the composite color comprises 4 inks.

4. Partial Gray Evaluation

The partial gray is the gray value of any one ink used in the composite color. This is determined by applying the following formula to a given ink component in the composite color:(1−ink partial luminance)=partial gray.

5. Principle Gray Evaluation

The principle gray threshold is determined by dividing the total gray of the losing object gray by the number of inks comprising the composite color of the losing objects plus an offset value between 0.0 and 0.1. The formula is as follows: total gray/(n+offset)=principle gray threshold where n=number of inks comprising the composite color of the losing object color.

Any partial gray of the composite color that is greater than the principle gray threshold will be component of a principle gray ink. The offset value is useful in the unlikely event that two or more inks that comprise the composite color have equal gray value. By using the offset, these ink values will cause the losing object to zero the trap amount on those plates. A greater offset will cause relatively more trap zeroing than a lesser one.

Use of the Evaluations

Once the values of the evaluations 1-5 are determined, the trap direction can then established. The term trap direction means either to spread, choke, knockout or overprint. In general, this is done by finding which of the two composite colors in a given trap relationship is lighter which is defined as greater total luminance. If the foreground object has a greater total luminance than the background, a spread will occur on all plates unless the ink on the current plate is considered a principle gray component of the background color in which case a knockout will occur. A choke will occur on all plates if the background has greater total luminance than the foreground object unless the ink on the current plate is considered a principle gray component of the foreground object in which case a knockout will occur.

Automatic Trapping Rules and Tests

In general, a trap relationship applies to the foreground object and the background of the foreground object. Even though a general trap relationship has been defined between two objects, exceptions are made on various plates. For example, if the foreground object is of greater luminance than the background object, it is considered to be a spread relationship. However on some plates the object may knockout or overprint depending on specific rules. The following rules apply to the specified trapping situations:

1. Spread In a spread relationship, if the current foreground ink is 0 on a given plate, the foreground object will knockout the background object unless the background is a rich black and the ink component of the rich black object is greater than or equal to the rich black threshold in which case the background object will knockout the foreground object. The rules for rich black are explained below.

2. Choke In a choke relationship, if the current background ink is 0 on a given plate, the background object will be knocked out by the foreground object unless the background object is a rich black and the ink component of the rich black object is greater than or equal to the rich black threshold in which case the foreground object will be knocked out by the background object.

3. Knockout The affect of a knockout is that of printing the foreground object with trap value of zero.

4. Overprint.

An object with any ink that has a partial gray value greater than or equal to the overprint limit will overprint those ink(s). The actual ink(s) that are greater than or equal to the overprint limit will knockout all previous backgrounds on the plate of the object while the other plates that are void of ink for that object will not print on those plates. Rich black objects will only overprint where the user has specific rules for overprint rich blacks.

5. Rich Black, Rich Black Threshold & Overprint Rich Black.

If the composite color of an object comprises any number of inks any one of which having a gray value that is greater than or equal to the Rich Black Threshold and comprises other inks less than the Rich Black Threshold is considered to be a rich black. The ink(s) having gray value(s) that exceed or equal the Rich Black Threshold are not limited to the Black ink.

6. Black & Overprint Limit.

If an object contains an ink(s) that has a gray value greater than or equal to the overprint limit and contains 0 percent of any other ink is considered to be black. The ink technically does not need to be the Black ink.

Resident Trapping Parameters

The system of a preferred embodiment of the present invention for automated trapping uses the following parameters to perform the appropriate output behavior: The trapping parameters of this preferred embodiment are:

a) automatic trap amount—(0-36).

b) overprint limit—(0-1).

c) rich black threshold—(0-1).

d) ink offset—(0-1).

e) principle gray offset—(0-1).

f) trap density—(0-1).

g) overprint rich black—(true/false).

h) trap traps—(true/false).

These parameters are explained below.

1. Automatic Trap Amount.

This is a trap value applied to designated objects.

2. Overprint Limit.

The overprint limit is a threshold value that is used in an evaluation to determine if an object will overflow an object contains a partial gray value that is greater than or equal to the overprint limit, the object will overprint. The ink color need not be any description of black.

3. Rich Black Threshold.

The Rich Black Threshold is a value that is used in an evaluation to determine if an object will be considered a rich black. If an object contains one or more partial gray values that are greater than or equal to the Rich Black Threshold as well as partial grays that are less than the Rich Black Threshold, the object is considered a rich black. The ink color with a partial gray value that exceeds the Rich Black Threshold need not be, technically, any description of black nor does an ink color with a partial gray value that is less the Rich Black Threshold restricted to process ink sets.

4. Ink Offset.

Ink Offset is a value used in an evaluation determining that mapping should not continue when the foreground object and the background object share a common ink and the percentage is less than or equal to the Ink Offset value.

5. Principle Offset Gray.

This is a value added to the number of inks comprising the losing object to prevent an inappropriate trap when each ink represents equal partial gray value.

6. Trap Density.

The Trap Density is a value that applies to the percentage of the ink applied by the winning object in the trap zone. This is to avoid an unnecessarily offensive color shift in the trap zone.

7. Overprint Rich Black.

The Overprint Rich Black parameter determines whether or not objects that are considered to be Rich Black will overprint other objects comprising exclusive inks.

8. Trap Traps.

Trap Traps parameter determines whether or not the trapping of an object will consider the trapping previously executed by the background object.

In use, the automated trapping system and processes can be used in association with a desktop publishing program or as a stand-alone system. In either case, the user will select either default values for the Trapping Parameters or choose their own selection for these parameters. The flow for the automated trapping process of a preferred embodiment of the present invention is described herein. Each object is initially painted. Then a trap zone is created for each of the objects. The trap zone is determined by the Automatic Trap Amount in the Trapping Parameters. Then each trap zone is painted by either the current ink value of the foreground object or the current ink value of the background object. This decision is determined by performing a series of evaluations.

First, values for the total luminance, the partial luminance, the total gray and the partial gray are determined for each of the two colors involved in a trapping relationship. Each color may have numerous ink(s) associated with it. Second, the direction of the trap is determined. The direction includes whether to choke, spread, knockout or overprint the foreground object color relative to the background color. This direction is determined by applying certain rules and exceptions based on evaluations of the luminance, partial luminance, total gray, partial gray, principle gray threshold and rich black values. Normally, if the foreground object is of greater luminance than the background object, then a spread relationship is selected. That is, the foreground object will knockout the background object. If the background object has a greater luminance than the foreground object, then a choke relationship occurs. An exception may apply depending on the rules for principle gray components and for rich black.

If any ink of an object has a partial gray value that is greater than the principle gray threshold, then that object on that ink plate will knockout the other object. If the composite color of an object has at least one ink that has a gray value that is greater than or equal to the Rich Black Threshold along with at least one ink that has a gray value less than the Rich Black Threshold, then that object will overprint. This feature must be toggled by the user in order to be operable.

An example of a trapping operation is illustrated in FIGS. 8-13. The artwork as shown in FIG. 8 includes multiple colors and shapes. The evaluations for each plate or ink is performed to decide whether adjacent areas are to be spread or choked. No trapping is performed for the Cyan plate in FIG. 9. The regions of the objects are spread or choked as shown by the arrows in the Magenta plate in FIG. 10 and the Yellow plate in FIG. 11 and as shown by the arrows in FIG. 12, the bar object is choked at certain points on the Black plate.

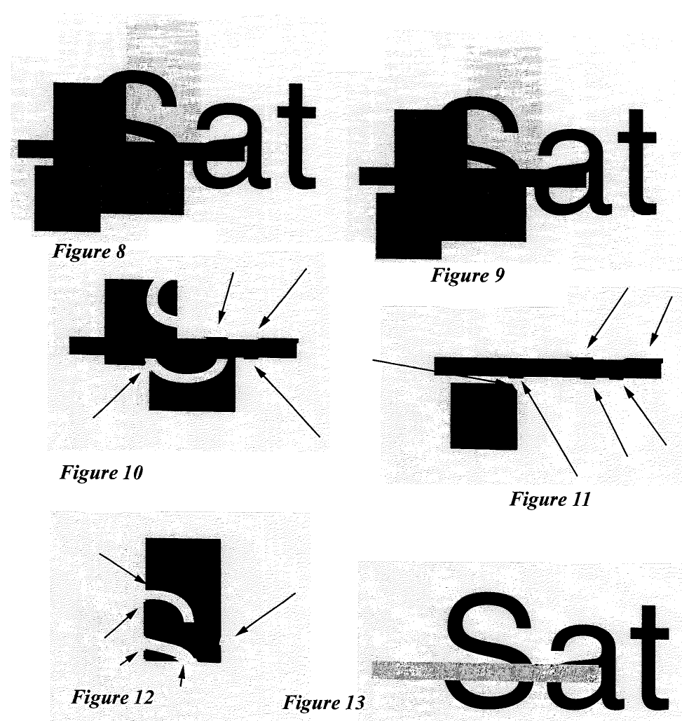

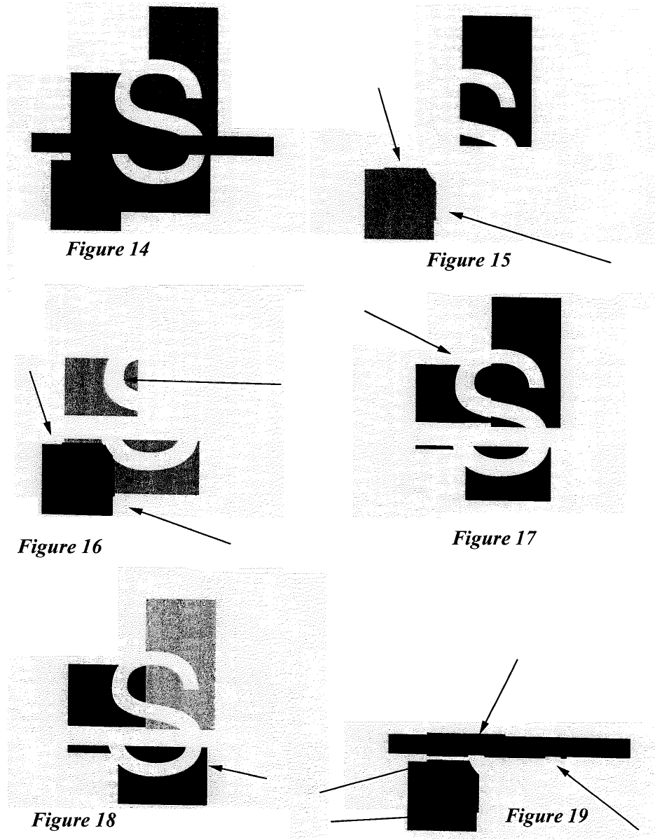

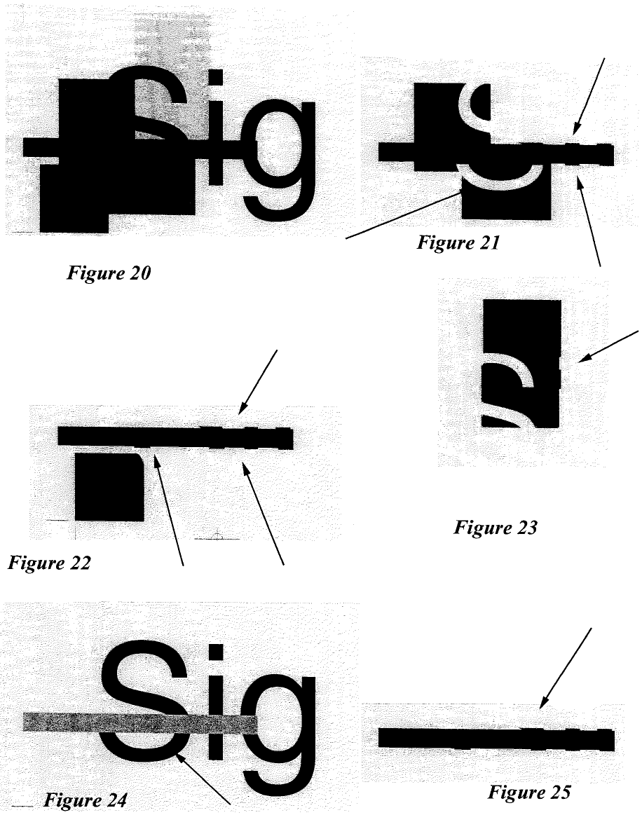

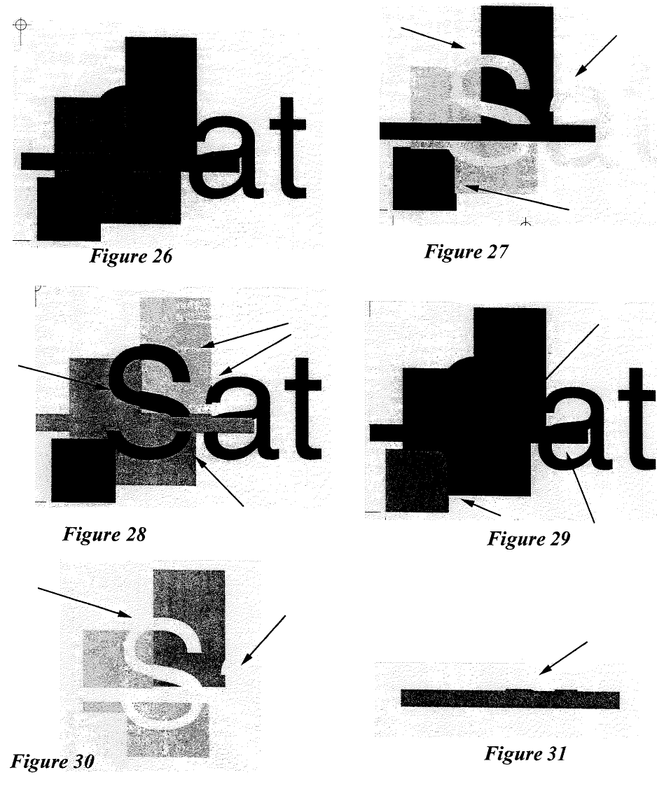

FIGS. 14-19 show even more dramatic examples of the selective trapping regions on the different inks. Another example of the trapping between selective regions of the objects on different inks are illustrated in FIGS. 20-25. Another example is illustrated in FIGS. 26-31.

It is to be expressly understood that the above descriptive embodiments are intended for descriptive purposes only and is not meant to limit the claimed invention. The present invention may be used in other embodiments as well. For example, the trapping system may include a decision making process that may, based on the luminance, the partial gray values, and/or the rich black threshold, not to apply trapping whatsoever. Also, the system of the present invention may also utilize additional evaluations to determine whether to apply trapping, the direction of trapping and/or the decision on the color to apply to the trapping region.

1. A method for correcting misregistration of printing separations, said method comprising the steps of:
paint each object;
create a trap zone relative to each adjacent object; evaluate the ink values of each object; and
determine the direction of trapping for each of said trap zones based on said evaluations of said ink values of each object.

2. The method of claim 1 wherein said method further includes the step of:
storing each object in the order of which it is created.

3. The method of claim 1 wherein said step of creating a trap zone includes:
defining the size of said trap zones.

4. The method of claim 1 wherein said step of evaluating the ink values of each of said objects includes the steps of:
evaluating the luminance of each of the ink values of each of said objects.

5. The method of claim 1 wherein said step of evaluating the ink values of each of said objects includes the steps of:
evaluating the total luminance of each of the two colors involved in the trapping relationship.

6. The method of claim 5 wherein said step of evaluating the total luminance for each of the two colors involved in the trap relationship by assessing the RGB values of each composite color by the formula (0.3 Red plus 0.59 Green plus 0.11 Blue) equals the total luminance.

7. The method of claim 1 wherein said step of evaluating the ink values of each of said objects includes the steps of:
evaluating the partial luminance of each of the ink values of each of the composite colors involved in the trap relationship.

8. The method of claim 7 wherein said evaluation of the partial luminance of each of the ink values of each of said objects assesses the RGB value of a given ink by the formula (0.3 Red plus 0.59 Green plus 0.11 Blue) equals the luminance of each ink.

8. The method of claim 1 wherein said step of evaluating the ink values of each of the colors involved in the trapping relationship includes the step of:
determining the partial gray of each of the composite colors.

9. The method of claim 1 wherein said step of evaluating the ink values of each of the colors involved in the trapping relationship includes the step of:
determining the partial gray of each of the composite colors by applying the formula of a given ink component in the composite color as (1 minus the partial luminance value of the ink) equals the partial gray.

10. The method of claim 1 wherein said step of evaluating the ink values of each of the colors involved in the trapping relationship includes the step of determining the principle gray threshold of the composite color.

11. The method of claim 1 wherein said step of evaluating the ink values of each of the colors involved in the trapping relationship includes the step of:
determining the principle gray threshold of the composite color by dividing the total gray of the composite color by combination of the total number of the inks of the composite color plus an offset value of less than 0.1.

12. The method of claim 1 wherein said step of determining the direction of trapping for each trap zone includes the step of:
determining the direction of each of the inks of the foreground object relative to the background object based on the luminance of the foreground object compared to the background object.

13. The method of claim 1 wherein said step of determining the direction of trapping for each trap zone includes the step of:
determining the direction of each of the inks of the foreground object relative to the background object based on the rich black values of the objects.

14. The method of claim 1 wherein said step of determining the direction of trapping for each trap zone includes the step of:
determining the direction of each of the inks of the foreground object relative to the background object based on the principle gray values of the objects.

15. The method of claim 1 wherein said step of determining the direction of trapping for each trap zone includes the step of:
spreading the foreground object relative to the background object when the luminance of the foreground object is greater than the background object unless the partial gray value of at least one ink component of either the foreground object or the background object is greater than the partial gray threshold in which case that object will knockout the other object for that ink component.

16. The method of claim 1 wherein said step of determining the direction of trapping for each trap zone includes the step of:
spreading the foreground object relative to the background object when the luminance of the foreground object is greater than the background object unless the partial gray value of at least one ink component of either the foreground object or the background object is greater than the rich black threshold and at least one ink component of that object is less than the rich black threshold in which case that object will overprint the other object for that ink component.

17. A method for correcting misregistration of printing separations, said method comprising the steps of: paint each object;
create a trap zone relative to each adjacent object; evaluate the ink values of each object to determine the luminance of each color, the partial luminance of each ink component of each color, the partial gray value of each ink component of each color; and
determine the direction of trapping for each of said trap zones based on said evaluations of said ink values of each object and upon thresholds for the partial gray and rich black.

18. The method of claim 17 wherein said method further includes the step of:
storing each object in the order of which it is created.

19. The method of claim 17 wherein said step of creating a trap zone includes:
defining the size of said trap zones.

20. The method of claim 17 wherein said step of evaluating the total luminance for each of the two colors involved in the trap relationship by assessing the RGB values of each composite color by the formula (0.3 Red plus 0.59 Green plus 0.11 Blue) equals the total luminance.

21. The method of claim 17 wherein said evaluation of the partial luminance of each of the ink values of each of said objects assesses the RGB value of a given ink by the formula (0.3 Red plus 0.59 Green plus 0.11 Blue) equals the luminance of each ink.

22. The method of claim 17 wherein said step of evaluating the ink values of each of the colors involved in the trapping relationship includes the step of:
determining the partial gray of each of the composite colors by applying the formula of a given ink component in the composite color as (1 minus the partial luminance value of the ink) equals the partial gray.

23. The method of claim 17 wherein said step of evaluating the ink values of each of the colors involved in the trapping relationship includes the step of:
determining the principle gray threshold of the composite color by dividing the total gray of the composite color by combination of the total number of the inks of the composite color plus an offset value of less than 0.1.

24. The method of claim 17 wherein said step of determining the direction of trapping for each trap zone includes the step of:
determining the direction of each of the inks of the foreground object relative to the background object based on the luminance of the foreground object compared to the background object.

25. The method of claim 17 wherein said step of determining the direction of trapping for each trap zone includes the step of:
determining the direction of each of the inks of the foreground object relative to the background object based on the rich black values of the objects.

26. The method of claim 17 wherein said step of determining the direction of trapping for each trap zone includes the step of:
determining the direction of each of the inks of the foreground object relative to the background object based on the principle gray values of the objects.

27. The method of claim 17 wherein said step of determining the direction of trapping for each trap zone includes the step of:
spreading the foreground object relative to the background object when the luminance of the foreground object is greater than the background object unless the partial gray value of at least one ink component of either the foreground object or the background object is greater than the partial gray threshold in which case that object will knockout the other object for that ink component.

28. The method of claim 17 wherein said step of determining the direction of trapping for each trap zone includes the step of:
spreading the foreground object relative to the background object when the luminance of the foreground object is greater than the background object unless the partial gray value of at least one ink component of either the foreground object or the background object is greater than the rich black threshold and at least one ink component of that object is less than the rich black threshold in which case that object will overprint the other object for that ink component.
